(19) United States
(12) Patent Application Publication
(10) Pub. No.: US 2011/0016300 A1
(43) Pub. Date: Jan. 20, 2011

(54) APPARATUS AND METHOD FOR FAST BOOTING COMPUTER SYSTEM

(76) Inventor: Joocheol LEE, Seoul (KR)

Correspondence Address: BIRCH STEWART KOLASCH & BIRCH, PO BOX 747, FALLS CHURCH, VA, 22040-0747, US

(21) Appl. No.: 12/561,763

(22) Filed: Sep. 17, 2009

(30) Foreign Application Priority Data
Jul. 14, 2009 (KR) 10-2009-0063944

(51) Int. Cl. G06F 9/24

(52) U.S. Cl. 713/2

(57) ABSTRACT

An apparatus and method for fast booting a computer system are provided. When a system power-off is requested in a computer system such as a desktop of notebook computer, a boot code comprising a BIOS code or the BIOS code and an OS kernel code is written to a specific area of a RAM, and then the computer system is turned off while continuously supplying power to the specific area of the RAM. When a system power-on is requested, the boot code written to the specific area of the RAM is executed to fast boot the computer system, thus effectively reducing a user's standby time until the completion of the system boot process.

This application claims the benefit of Korea Patent Application No. 10-2009-0063944 filed on Jul. 14, 2009, which is incorporated herein by reference for all purposes as if fully set forth herein.

### BACKGROUND

1. Field

This document relates to an apparatus and method for fast booting a computer system.

2. Related Art

In general, desktop and notebook computers comprise a processor 10, a device controller 11, a memory controller 12, a read only memory (ROM) 13, a hard disk drive (HDD) 14, and a random access memory (RAM) 15 as shown in FIG. 1.

Meanwhile, a basic input/output system (BIOS) code and an operating system (OS) kernel code required to boot a computer system are recorded in the ROM 13. For example, as shown in FIG. 2, the BIOS code is recoded in a boot block at addresses from FFFD0000h to FFFFFFFh allocated in the ROM 13, and the OS kernel code is recorded in a specific area at addresses from FF000000h to FFE80000h in the ROM 13.

Moreover, the OS kernel code may be recorded in the form of an OS kernel image, and the BIOS code and the OS kernel code may be recorded in the HDD 14. For example, when the system power is on, the device controller 11 reads the BIOS code recorded in the boot block of the ROM 13 and the OS kernel code recorded in the specific area of the ROM 13.

Then, the memory controller 12 writes the BIOS code and the OS kernel code, read by the device controller 11, to a specific area of the RAM 15. Subsequently, the processor 10 executes the BIOS code and the OS kernel code written to the RAM 15 to perform a system boot process.

Meanwhile, the processor 10 and the RAM 15 correspond to a central processing unit (CPU) and a dynamic random access memory (DRAM), for example. Upon completion of the system boot process, the BIOS code and the OS kernel code written to the RAM 15 are deleted, and other application programs are written.

Moreover, when a system power-off is requested by a user's key input, the processor 10 converts the system power into S4 or S5, a system power-off state defined by Microsoft Windows, for example.

Next, when a system power-on is requested, the BIOS code recorded in the boot block of the ROM 13 and the OS kernel code recorded in the specific area of the ROM 13 are read and written to the specific area of the RAM 15. Subsequently, the written BIOS code and the OS kernel code are executed to perform the system boot process. The BIOS code or the BIOS code and the OS kernel code may be referred to as a boot code.

However, it takes more than one second, for example, to read the boot code recorded in the boot block and the specific area of the ROM 13 and write the boot code in the specific area of the RAM 15, and thereby the user's standby time until the completion of the system boot process is slightly increased.

### SUMMARY

This document provides an apparatus and method for fast booting a computer system, which can fast boot various types of computer systems such as desktop and notebook computers by executing a boot code written in a specific area of a RAM when the computer system is turned on.

An aspect of this document is to provide a method for fast booting a computer system, the method comprising: writing a boot code recorded in a read only memory (ROM) or hard disk drive (HDD) to a predetermined specific area of a random access memory (RAM) when a system power-off is requested; turning off the computer system while continuously supplying power to the specific area of the RAM; and fast booting the computer system by reading the boot code written to the specific area of the RAM when a system power-on is requested after the turning off of the computer system.

Another aspect of this document is to provide an apparatus for fast booting a computer system, the apparatus comprising: a device controller reading a boot code recorded in a read only memory (ROM) or hard disk drive (HDD); a memory controller writing the boot code to a predetermined specific area of a random access memory (RAM); and a processor booting the computer system by reading the boot code written to the specific area of the RAM, wherein, when a system power-off is requested, the processor turns off the computer system by controlling the operations of the device controller and the memory controller such that the boot code is written to the specific area of the RAM while continuously supplying power to the specific area of the RAM and, when a system power-on is requested, the processor fast boots the computer system by reading the boot code written to the specific area of the RAM.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram showing a configuration of a computer system;

FIG. 2 is a schematic diagram showing an example of a BIOS code and an OS kernel code recorded in a boot block and a specific area of a ROM;

FIG. 3 is a schematic diagram showing a computer system applied to an apparatus and method for fast booting a computer system in accordance with exemplary embodiments of the present invention; and

FIGS. 4 and 5 are flowcharts illustrating a method for fast booting a computer system in accordance with an exemplary embodiment of the present invention.

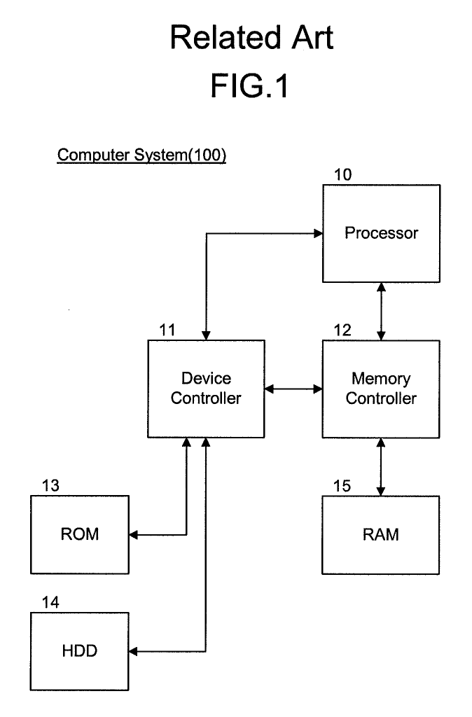

### DETAILED DESCRIPTION OF THE ILLUSTRATED EMBODIMENTS

The above and other objects, features and advantages of the present invention will be more apparent from the following detailed description taken in conjunction with the accompanying drawings. Hereinafter, exemplary embodiments of the present invention will be described with reference to the accompanying drawings. Like reference numerals designate like elements throughout the specification. In the following description of the embodiment of the present invention, a detailed description of known functions and configurations incorporated herein will be omitted when it may obscure the subject matter of the present invention.

An apparatus and method for fast booting a computer system in accordance with exemplary embodiments of the present invention are applicable to various types of computer systems such as desktop and notebook computers.

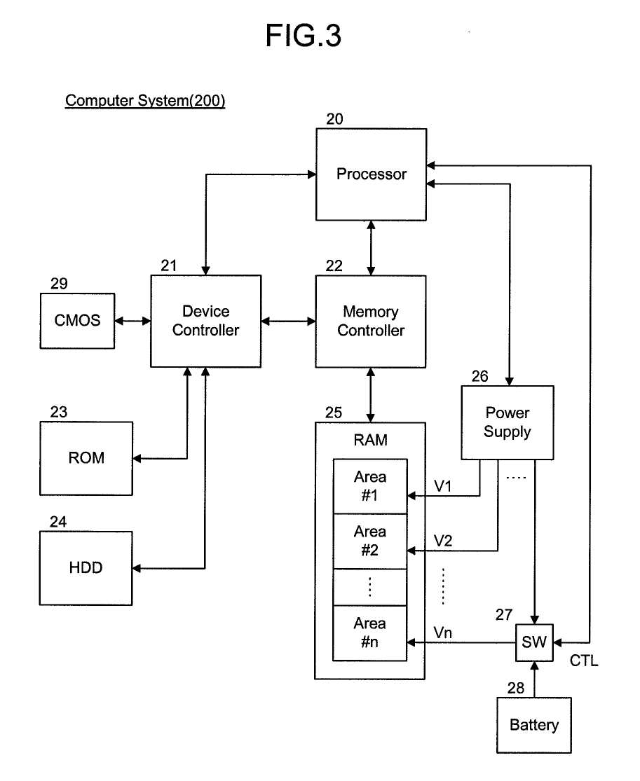

For example, a computer system to which the present invention is applied comprises a processor 20, a device controller 21, a memory controller 22, a read only memory (ROM) 23, a hard disk drive (HDD) 24, a random access memory (RAM) 25, a power supply 26, a switch 27, a battery 28, and a complementary metal oxide semiconductor (CMOS) 29 as shown in FIG. 3.

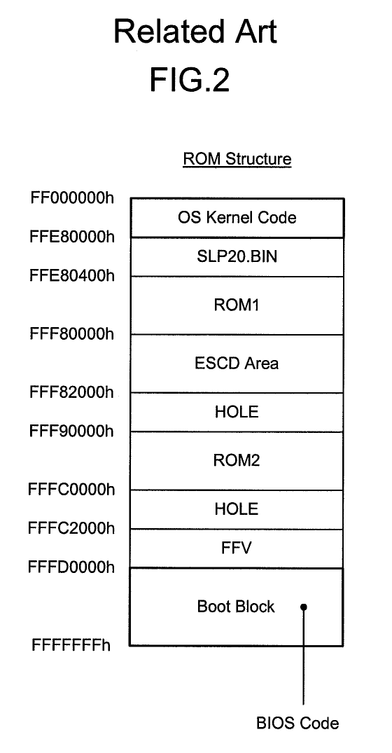

Meanwhile, a basic input/output system (BIOS) code and an operating system (OS) kernel code are recorded in the ROM 23. For example, as described above with respect to FIG. 2, the BIOS code and the OS kernel code, required to boot the computer system, are recoded in the boot block at addresses from FFFD0000h to FFFFFFFh and the specific area at addresses from FF000000h to FFE80000h allocated in the ROM 23, respectively. The OS kernel code may be recorded in the form of an OS kernel image.

Moreover, the OS kernel code may be recorded in the HDD 24. The device controller 21 reads the BIOS code recorded in the boot block of the ROM 23 and the OS kernel code recorded in the specific area of the ROM 23.

The memory controller 22 writes the BIOS code or a boot code comprising the BIOS code and the OS kernel code, read by the device controller 21, to a specific area of the RAM 25. Subsequently, the processor 20 executes the boot code written to the RAM 25 to perform a system boot process.

Meanwhile, the processor 20 and the RAM 25 correspond to a central processing unit (CPU) and a dynamic random access memory (DRAM), for example. Upon completion of the system boot process, the boot code written to the RAM 25 is deleted, and other application programs are written.

Moreover, when a system power-off is requested by a user's key input, the processor 20 converts the system power into S4 or S5, a system power-off state defined by Microsoft Windows, for example. Prior to this, the processor 20 controls the operations of the device controller 21 and the memory controller 22 to write the BIOS code or the boot code comprising the BIOS code and the OS kernel code, recorded in the ROM 23, to a specific area (e.g., Area #n) of the RAM 25.

At the same time, the processor 20 controls the switch 27 such that the power of the computer system is off after the power of the battery 28 is continuously supplied to the specific area of the RAM 25. Next, when a system power-on is requested, the processor 20 fast boosts the computer system by reading the boot code written to the specific area of the RAM 25, which will be described in more detail below.

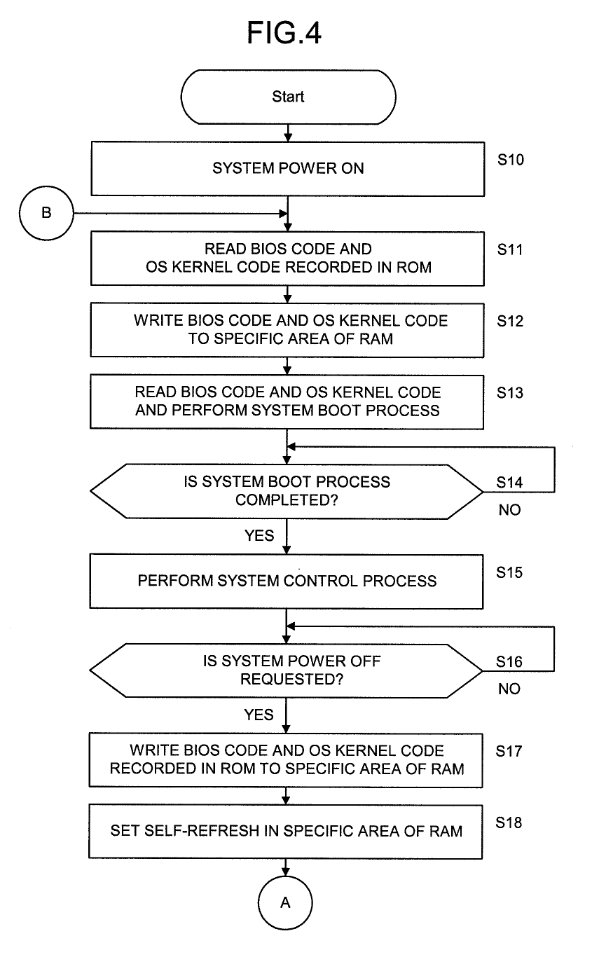

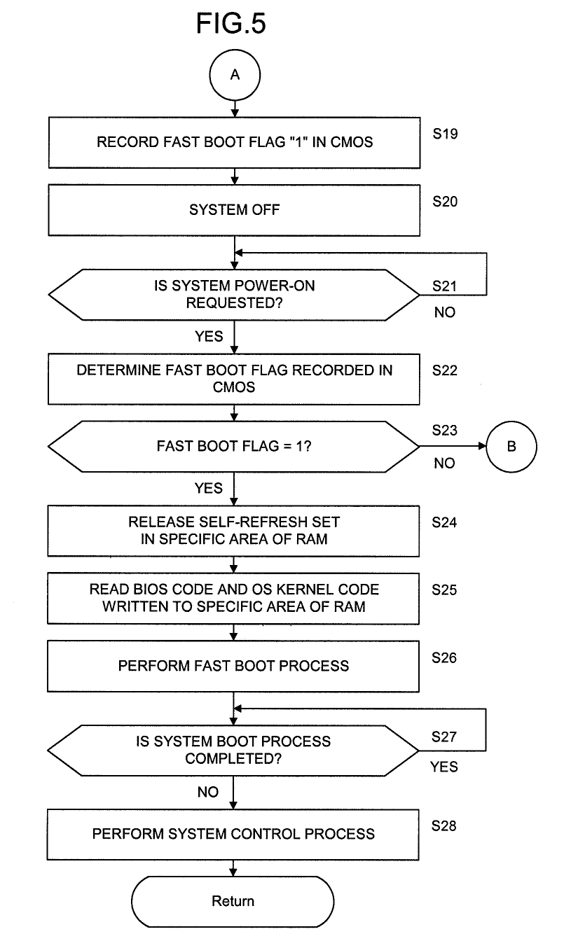

FIGS. 4 and 5 are flowcharts illustrating a method for fast booting a computer system in accordance with an exemplary embodiment of the present invention. When the power of the computer system such as a desktop or notebook computer to which the present invention is applied is on (S10), the device controller 21 reads the boot code recorded in the ROM 23, for example, the BIOS code and the OS kernel code recorded in the boot block and the specific area of the ROM 23 (S11).

Moreover, the memory controller 22 writes the boot code, for example, the BIOS code and the OS kernel code, read by the device controller 21, to a specific area (e.g., Area #n) of the RAM 25 (S12).

Subsequently, the processor 20 reads the BIOS code and the OS kernel code written to the specific area of the RAM 25 to perform a system boot process (S13). Upon completion of the system boot process (S14), the processor 20 performs a system control process (S15).

Meanwhile, when a system power-off is requested by a user's key input (S16), the processor 20 controls the operations of the device controller 21 and the memory controller 22 to write the BIOS code and the OS kernel code, recorded in the boot block and the specific area of the ROM 23, to a specific area (e.g., Area #n) of the RAM 25 (S17).

Then, the processor 20 shifts the switch 27 to set a self-refresh in the specific area of the RAM such that minimal power of the battery 28 is continuously supplied to the specific area of the RAM 25 (S18), and the device controller 21 records identification information indicating that the BIOS code and the OS kernel code have been written to the specific area of the RAM 25 in the CMOS 29 (S19).

For example, the identification information may be recorded as a fast boot flag of more than one bit. When the fast boot flag is recorded as “1”, the identification information indicates that the boot code such as the BIOS code and the OS kernel code has been written to the specific area of the RAM 25. Whereas, when the fast boot flag is recorded as “0”, the identification information indicates that no boot code has been written to the specific area of the RAM 25.

Meanwhile, the processor 20 controls the operation of the power supply 26 to convert the system power into S4 or S5, a system power-off state defined by Microsoft Windows, for example (S20).

Next, when a system power-on is requested (S21), the device controller 21 determines the fast boot flag recorded in the CMOS 29 (S22).

If the fast boot flag is “1” (S23), it is determined that the boot code such as the BIOS code and the OS kernel code has been written to the specific area of the RAM 25. Whereas, if the fast boot flag is “0”, it is determined that no boot code has been written to the specific area of the RAM 25.

When it is determined that no boot code has been written to the specific area of the RAM 25, the boot code recorded in the boot block and the specific area of the ROM 23 is read and written to the specific area of the RAM 25.

On the contrary, when it is determined that the boot code has been written to the specific area of the RAM 25, the self-refresh set in the specific area of the RAM 25 is released (S24) such that the power Vn of the power supply 26 is supplied to the specific area of the RAM 25.

Moreover, the boot code written to the specific area of the RAM 25 is read (S25) to perform a fast boot process (S26). Then, upon completion of the system boot process (S27), the processor 20 performs the system control process (S28).

Therefore, it is possible to reduce the time (e.g., more than one second) required to read the boot code recorded in the boot block and the specific area of the ROM 23 and write the boot code to a specific area of the RAM 25, thus effectively reducing the user's standby time until the completion of the system boot process.

For reference, OS kernel image data may be recorded in the specific area of the RAM 25 in a compressed state besides the BIOS code and the OS kernel code.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for fast booting a computer system, the method comprising:
writing a boot code, previously recorded in a read only memory (ROM) or hard disk drive (HDD), to a predetermined specific area of a random access memory (RAM) of the computer system when a system power-off is requested;
turning off the computer system while continuously supplying power to the specific area of the RAM; and
after the turning off of the computer system, fast booting the computer system by reading the boot code written to the specific area of the RAM when a system power-on is requested.

2. The method of claim 1, wherein the boot code comprises a basic input/output system (BIOS) code with or without an operating system (OS) kernel code.

3. The method of claim 1, wherein the step of writing of the boot code comprises:
additionally recording, in a nonvolatile memory of the computer system, identification information indicating that the boot code has been written to the specific area of the RAM.

4. The method of claim 3, wherein the identification information is a fast boot flag of more than one bit, and the nonvolatile memory is a complementary metal oxide semiconductor (CMOS) controlled by a device controller of the computer system.

5. The method of claim 1, wherein the step of turning off of the computer system comprises:
converting the system power into Microsoft Windows power-off state S4 or Microsoft Windows power-off state S5 by setting a self-refresh in the specific area of the RAM such that minimal power of a battery is continuously supplied to the specific area of the RAM.

6. The method of claim 3, wherein the step of fast booting of the computer system comprises:
determining if the identification information is recorded into the non-volatile memory; and
the step of determining indicates that the identification information is recorded into the non-volatile memory, reading the boot code written to the specific area of the RAM.

7. The method of claim 3, wherein the step of fast booting of the computer system comprises:
determining if the identification information is recorded into the non-volatile memory; and
if the step of determining indicates that the identification information is not recorded into the non-volatile memory, fast booting the computer system by reading the boot code recorded in the ROM or HDD, writing the boot code to the specific area of the RAM, and reading the boot code written to the specific area of the RAM.

8. The method of claim 1, wherein the boot code recorded in the ROM or HDD is read by the device controller, and the boot code written to the specific area of the RAM is read by a memory controller of the computer system.

9. An apparatus for fast booting a computer system, the apparatus comprising:
a device controller configured to read a boot code recorded in a read only memory (ROM) or hard disk drive (HDD);
a memory controller configured to write the boot code to a predetermined specific area of a random access memory (RAM); and
a processor configured to boot the computer system by reading the boot code written to the specific area of the RAM, wherein
when a system power-off is requested, the processor is configured to turn off the computer system by controlling the operations of the device controller and the memory controller such that the boot code is written to the specific area of the RAM while continuously supplying power to the specific area of the RAM, and
when a system power-on is requested, the processor is configured to fast boot the computer system by reading the boot code written to the specific area of the RAM.

10. The apparatus of claim 9, wherein the boot code comprises a basic input/output system (BIOS) code with or without an operating system (OS) kernel code.

11. The apparatus of claim 9, wherein the device controller is configured to record, in a nonvolatile memory, identification information indicating that the boot code has been written to the specific area of the RAM.

12. The apparatus of claim 11, wherein the identification information is a fast boot flag of more than one bit, and the nonvolatile memory is a complementary metal oxide semiconductor (CMOS) controlled by the device controller.

13. The apparatus of claim 9, wherein the processor is configured to convert the system power into Microsoft Windows power-off state S4 or Microsoft Windows power-off state S5 by setting a self-refresh in the specific area of the RAM such that minimal power of a battery is continuously supplied to the specific area of the RAM.

14. The apparatus of claim 11, wherein the processor is configured to determine if the identification information is recorded in the nonvolatile memory and, if the identification information is determined to be recorded in the non-volatile memory, fast boot the computer system by reading the boot code written to the specific area of the RAM.

15. The apparatus of claim 11, wherein the processor is configured to determine if the identification information is recorded in the nonvolatile memory and, if the identification information is determined not to be recorded in the non-volatile memory, fast boot the computer system by reading the boot code recorded in the ROM or HDD, write the boot code to the specific area of the RAM, and read the boot code written to the specific area of the RAM.
